(19) United States
(12) Patent Application Publication
(10) Pub. No.: US 2009/0003253 A1
(43) Pub. Date: Jan. 1, 2009

(54) Controlling wireless network beacon transmission

(75) Inventors: Huizhao Wang, San Jose, CA (US); Frederick Dean, Sunnyvale, CA (US)

Correspondence Address: Tropos Networks, PO Box 641867, San Jose, CA, 95164-1867, US

(73) Assignee: Tropos Networks, Inc.

(21) Appl. No.: 11/823,948

(22) Filed: Jun. 29, 2007

(51) Int. Cl. G08C 17/00

(52) U.S. Cl. 370/311

(57) ABSTRACT

Methods of an access node of a wireless network controlling beacon transmission are disclosed. The method includes the access node detecting a presence of a client device, and the access node controlling air-time of beacon transmission based on whether the access node detects the presence of a client device.

### FIELD OF THE EMBODIMENTS

The described embodiments relate generally to wireless communications. More particularly, the described embodiments relate to a method and apparatus for controlling wireless network beacon transmission.

### BACKGROUND

Wireless networks are gaining popularity because wireless infrastructures are typically easier and less expensive to deploy than wired networks. However, wireless networks can be susceptible to environmental conditions, interference and self-interference.

Access points of wireless networks can provide client devices with wireless access to the networks. For example, FIG. 1 shows a wireless network in which access points 120, 122, 124. The access points 120, 122, 124 are typically wire connected to a wired network 140 that is connected, for example, to the internet.

Typically, wireless access points (such as access points 120, 122, 124) transmit beacons (1A-1N, 2A-2N, 3A-3N) that provide a client device with information, for example, regarding networks that the wireless access points support. One exemplary implementation of the beacons includes MAC (media access control) addresses, such as, BSSID (base service set identification) beacons. Based upon the received beacons, the client device can select which access points, and therefore, which networks to associate with. The transmission of the beacons, however, occupies valuable transmission air-time. That is, the transmission of the beacons occupies transmission air-time that can reduce the usability of the air-time to other types of wireless communications.

FIG. 2 shows a time-line and depicts Beacons being randomly transmitted from multiple access nodes. The spacing of the beacons can be such that they reduce the usable air-time space available for other wireless network transmissions. That is, for example, medium access protocols such as 802.11 implement Carrier Sense Multiple Access with Collision Avoidance (CSMA/CA). In such protocols, transceivers sense a channel (link) and defer transmissions while the channel is considered to be busy. The channel is deemed to be busy if a received signal exceeds a Clear Channel Assessment Threshold (CCAT). Once the CCAT has been tripped, the 802.11 devices can no longer transmit any signals. Therefore, an 802.11 device in the presence of many randomly transmitted beacons can be limited to transmitted data in a very limited amount of air-time.

For a wireless network that includes a high density of access points (access nodes), such as a wireless mesh network, the air-time occupied by the beacons transmitted by the access nodes can become undesirably large, and effectively reduce the usable air-time of the wireless network.

It is desirable for a wireless network to transmit multiple beacons while attempting to maximize the usable airtime available to devices of the wireless network.

### SUMMARY

One embodiment includes a method of an access node of a wireless network controlling beacon transmission. The method includes the access node detecting a presence of a client device, and the access node controlling air-time of beacon transmission based on whether the access node detects the presence of a client device.

Another embodiment includes a method of an access node of a wireless network controlling beacons sent from multiple local addresses. The method include detecting which of the multiple local addresses have at least one client device present, and controlling air-time of beacon transmission of each of the multiple local addresses depending upon whether the local address have detected at least one client device being present.

Another embodiment includes a method of controlling beacons of multiple local addresses transmitted from a plurality of access nodes of a wireless mesh network. The method includes each of a plurality of access nodes of the wireless mesh network transmitting a plurality of different local addresses. The plurality of access nodes each detect whether at least one client device is present with the access node because of transmission of one of the different local addresses. Each access node controls air-time of beacon transmission of each of the multiple local addresses depending upon whether the local address have detected at least one client device being present.

Other aspects and advantages of the described embodiments will become apparent from the following detailed description, taken in conjunction with the accompanying drawings, illustrating by way of example the principles of the described embodiments.

### BRIEF DESCRIPTION OF THE DRAWINGS

FIG. 1 shows a wireless network in which access points of the wireless network each broadcast beacons.

FIG. 2 is a time-line showing multiple beacon types being broadcast from multiple wireless access points.

FIG. 3 is a flow chart that includes steps of one example of a method an access node of a wireless network controlling beacon transmission.

FIG. 4 is a flow chart that includes steps of one example of a method of an access node of a wireless network controlling beacons sent from multiple local addresses

FIG. 5A shows a time-line of an example of controlling a time interval between beacon transmissions.

FIG. 5B shows a time-line of an example of controlling a rate of symbol transmission of the beacons.

FIG. 5C shows a time-line of an example of controlling a preamble length of the beacons.

FIG. 6 shows one example of a wireless mesh network that includes access nodes that control timing of the transmission of multiple beacon types.

FIG. 7 show one example of a method of controlling beacons of multiple local addresses transmitted from a plurality of access nodes of a wireless mesh network.

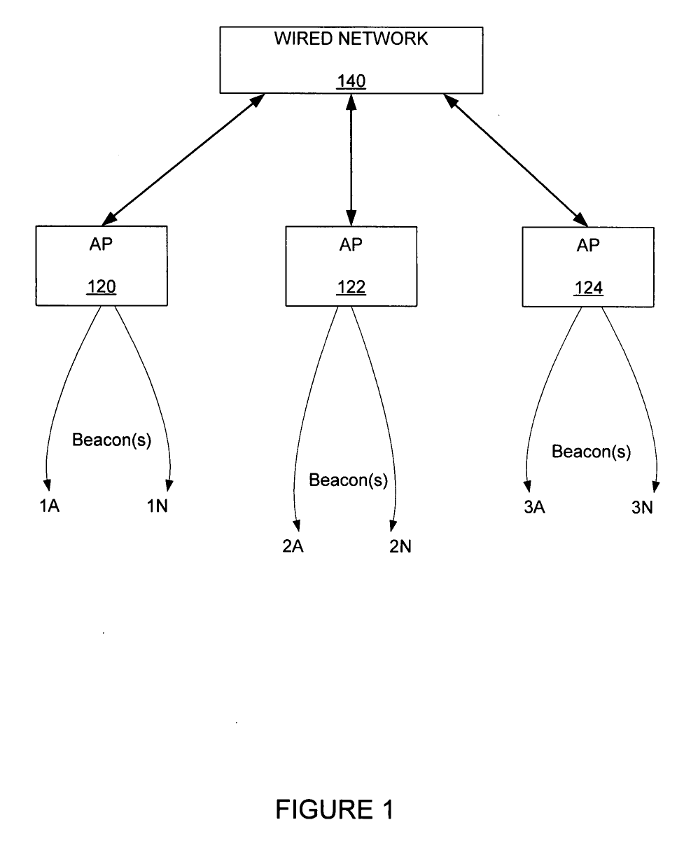

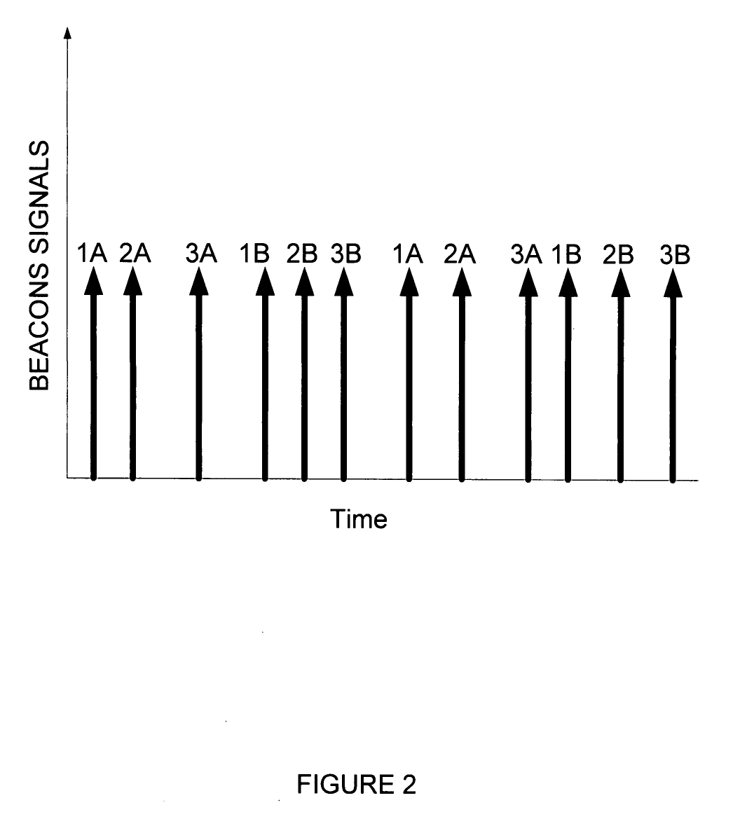

### DETAILED DESCRIPTION

As shown in the drawings for purposes of illustration, the described embodiments are embodied in an apparatus and method for controlling transmissions of beacons, resulting in more air-time capacity than if the beacons are not controlled. Access nodes of a wireless network control air-time of beacon transmission based on whether the access nodes detects the presence of a client device. The beacons can include, for example, BSSID beacons.

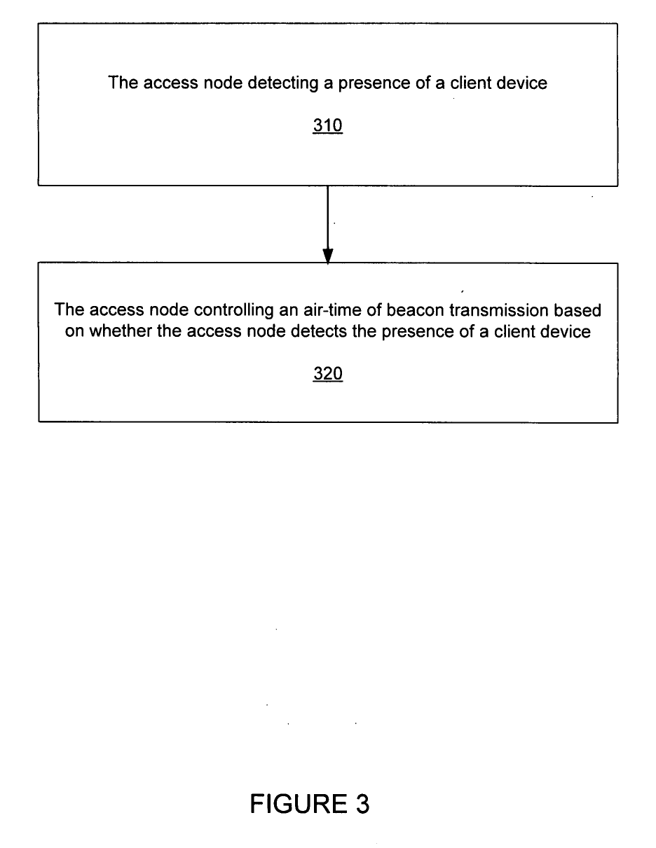

FIG. 3 is a flow chart that includes steps of one example of a method an access node of a wireless network controlling beacon transmission. A first step 310 of the method includes the access node detecting a presence of a client device. A second step 320 includes the access node controlling air-time of beacon transmission based on whether the access node detects the presence of a client device.

The method provides an intelligent method of throttling (reducing) the number of for example, beacons. The reduction in transmitted beacon improves (increases) the available air-time, thereby decreasing the possibility of collision between transmitted beacons.

Detecting the Presence of a Client

The presence of clients can be detected in one of several different ways. For example, client presence can be determined by sensing whether a client device recently probed the access node, whether a client device is associated with the access node, whether a client device recently dis-associated with the access node, whether a client device has been authenticated. Client presence can also be detected by observing traffic between client devices and other access points.

Controlling Beacon Air-Time Transmission

Examples of methods of controlling the air-time of beacon (for example, a layer two 802.11 BSSID beacon) transmission include controlling a time interval between beacon transmissions, controlling a rate of symbol transmission of the beacons, and/or controlling a preamble length of the beacons. It should be understood that generally the access node transmits at least some beacons regardless of whether the access node detects the presence of a client device. Detection of the lack of presence of a client allows the air-time occupied by the beacons to be reduced.

If at least one client is detected, the air-time occupied by the beacons can in some situation still be reduced. For example, of the client device is in a sleep or idle mode, the beacon air-time may still be reduces. If a presence of a client device is detected, then a mode of the client device is determined. If the client device is in one of certain modes, then the air-time occupied can be decreased by increasing a time interval between beacon transmissions, increasing bit rates of the beacons, and/or decreasing a length of a preamble of the beacons. For an exemplary embodiment, if the client device is in the power-save mode (for example, sleep or idle), then beacons are only transmitted when an 802.11 beacon DTIM (traffic indication map) count is zero (or any other selected number as will be described later).

For an embodiment, one of the certain modes includes treating a client device as though it is idle or sleeping if the client has been inactive for a predetermined period of time. That is, if the client device does not have any data traffic or has not sent any traffic besides responses elicited by the network using, for example, ARP (address resolution protocol) or ping (ICMP echo_request), then the client device may be treated as though it is idle, and the beacons controlled accordingly.

As previously described, several methods can be used to control the air-time occupied by the transmitted beacons. For example, a time interval between beacon transmissions can be increase, the bit rates of the beacons can be increased, or a length of a preamble of the beacons can be decreased.

Another embodiment includes additionally controlling air-time of beacon transmission based on how many client devices the access node detects present. The air-time control can be determined by referencing a schedule, wherein the schedule provides the air-time control depending upon how many client devices the access node detects.

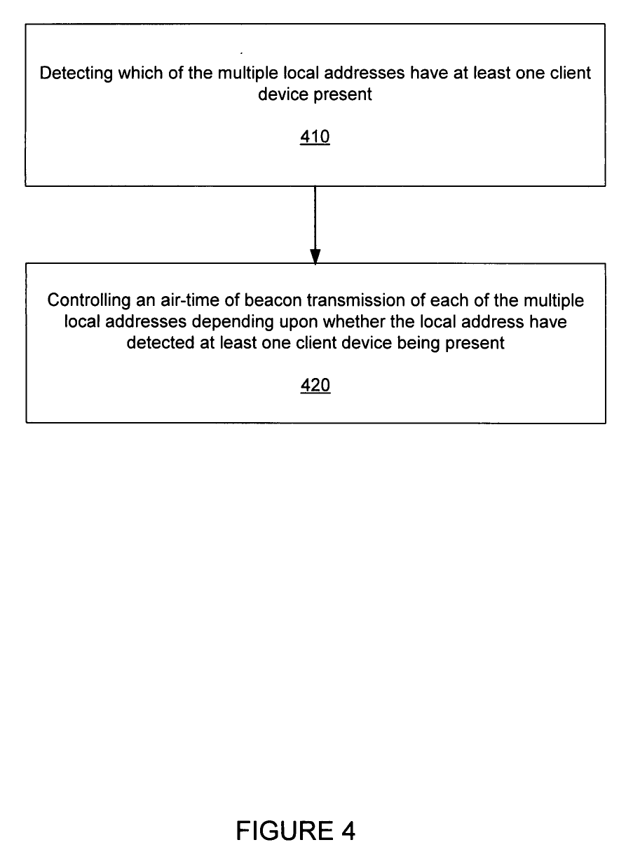

FIG. 4 is a flow chart that includes steps of one example of a method an access node of a wireless network controlling multiple beacon transmissions. A first step 410 of the method includes detecting which of the multiple local addresses have at least one client device present. A second step 420 includes controlling air-time of beacon transmission of each of the multiple local addresses depending upon whether the local address have detected at least one client device being present.

The multiple local addresses can correspond, for example, to different personalities. The different personality types can be defined by an authentication type (for example, WEP, Open, WPA, WPA2), a WME, WMM, backend services, such as, service provided and the network connected to, and the allowable bandwidth. As previously stated, each personality type has its own MAC address. Additionally, beacon types can provide ESSIDs, and features and symbol rates supported.

The air-time of beacon transmission of each can be controlled for each of the multiple local addresses. For local addresses that do not have a detected client device, a time interval between beacon transmissions can be increased, the bit rates of the beacons can be increased, and/or a preamble length of the beacons can be decreased.

If at least one client device is determined to be present, and the client device is operating in a sleep mode, the air-time occupies for beacon transmission can still be reduced. For example, if all client devices detected present for each local address are operating in the sleep mode, then a time interval between beacon transmissions can be increased, bit rates of the beacons can be increased, and/or a length of the preamble of the beacons can be decreased, for each local address.

Another embodiment includes additionally controlling the air-time of beacon transmission of each of the multiple local addresses based on how many client devices are present because of frames sent by client device to the local address. Local addresses having fewer client devices present can be controlled to occupy less air-time than local addresses having more client devices. That is, local address are favored (allotted greater air-time) if client communication results due to the local address.

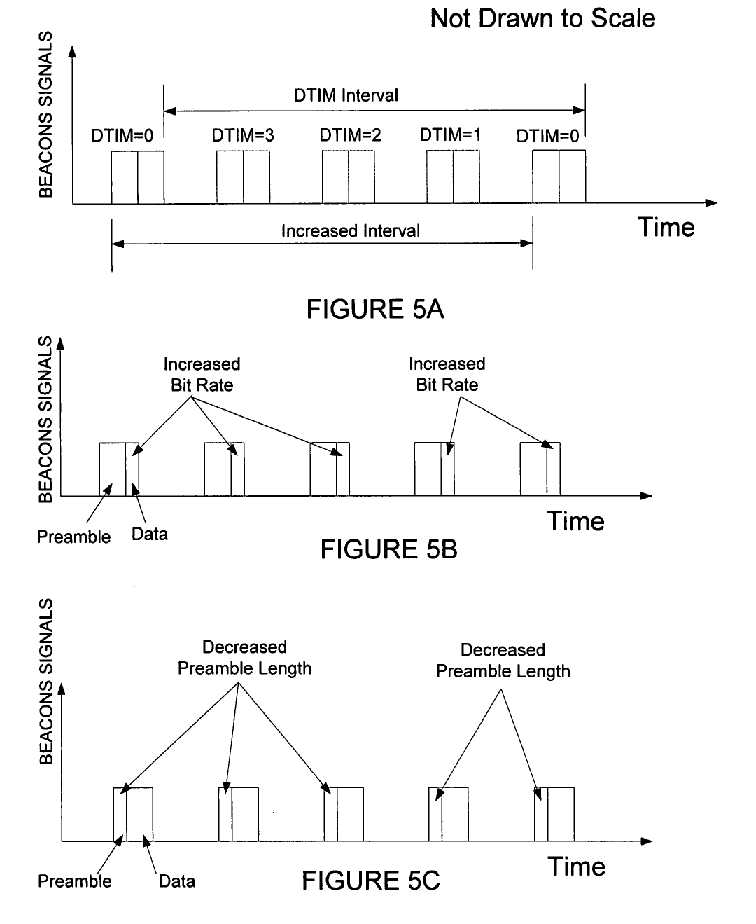

FIG. 5A shows a time-line of an example of controlling a time interval between beacon transmissions. As shown, the interval period between beacon transmissions is increased if at least one of the previously described conditions is present. That is, the time interval between transmitted beacons is increased if no client device is detected present, or if detected present, and the client device is in a sleep or idle mode. As previously mentioned, one embodiment includes only transmitting beacons when an 802.11 DTIM count is zero. As shown, a DTIM count can include four beacons, with a count sequence of 3-2-1-0. Any of the four DTIM counts can be selected for beacon transmission, reducing the beacon transmission by ¼th. That is, the beacons can be transmitted at a DTIM count of 3 or 2 or 1 or 0. Generally, the DTIM determines the times for access nodes to multicast or broadcast, and therefore, sets the time in which sleeping clients are to check for pending frames targeted for the sleeping clients. The DTIM sets the time in which a sleeping client is to receive buffered multicast or broadcast frames.

FIG. 5B shows a time-line of an example of controlling a rate of symbol transmissions of the beacons. Controlling the rate of symbol transmission can be used to reduce the amount of time occupied during data transmission, resulting in less occupation of air-time. The time-line is not to scale, but depicts a reduction in data transmission time due to an increase in the rate of symbol transmission.

FIG. 5C shows a time-line of an example of controlling a preamble length of the beacons. Similar to the rate of symbol transmission control, controlling the preamble length can be used to reduce the time duration of the beacons, and therefore, result in less occupation of air-time.

BSSID Beacon Timing within a Wireless Mesh Network

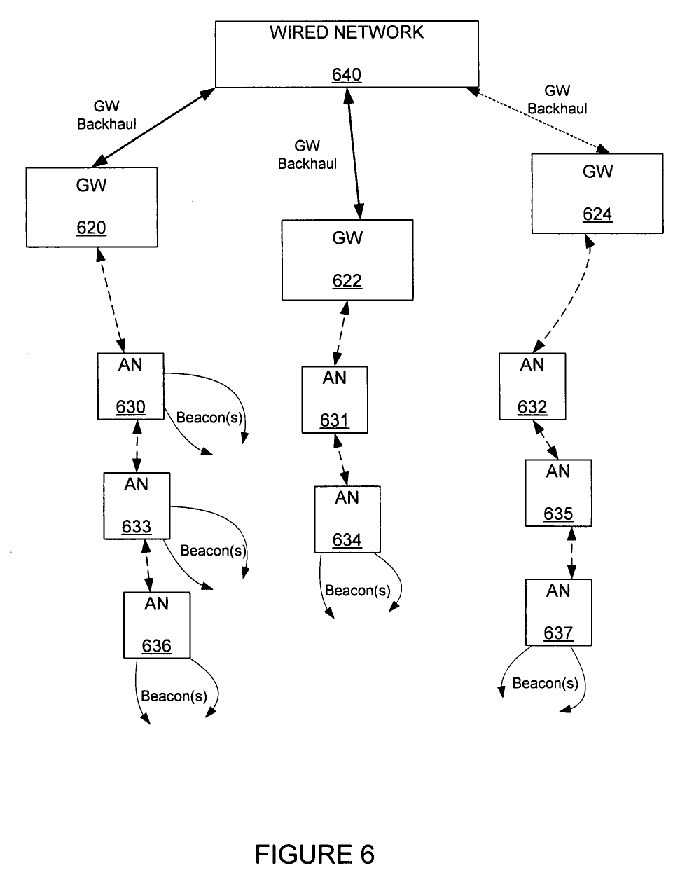

FIG. 6 shows a wireless mesh network that includes access nodes that each control timing of broadcast beacons. Wireless mesh networks include many transmitting devices (gateways and access nodes) that can each be broadcasting beacons. As a result, wireless mesh networks can be particularly susceptible to the air-time availability problems that randomly broadcasting beacons can cause. The methods of increasing available air-time by controlling the broadcasting of beacons, are particularly useful for wireless mesh networks.

The wireless mesh network includes gateways 620, 622, 624 and access nodes 630, 631, 632, 633, 634, 635, 636, 637. Client devices can connect to a wired network 640 through the gateways 620, 622, 624 and access nodes 630, 631, 632, 633, 634, 635, 636, 637.

The gateways 620, 622, 624 can be wirelessly or wire connected to the wired network 640. The gateways 620, 622, 624 can also be access nodes or access points in that the gateways 620, 622, 624 can directly provide client devices with access to the wired network 640.

An embodiment includes the gateways and each of the access nodes transmitting beacons having multiple local addresses. The gateways and/or the access nodes can control the air-time usage of the transmitted beacons using the beacon air-time control methods described. That is, each gateway and access node can detect whether at least one client device is present with the gateway or access node because of transmission of one of the different local addresses. The gateways and access nodes can then control air-time of beacon transmission of each of the multiple local addresses depending upon whether at least one client device are detected present because of the local address.

The gateways and access nodes can use previously described methods for detecting whether at least one client device is present. Additionally, the gateways and access nodes can use the previously described methods of controlling the air-time of beacon transmission of each of the multiple local addresses. The gateways can determine whether the client devices that are detected present for each local address are operating in a select mode. If in one of the previously describe select modes (for example, sleep or idle modes) the beacon transmission can be controlled to reduce the air-time occupied by the beacons. Additionally, each gateways and node can control the air-time of beacon transmission of each of the multiple local addresses based on how many client devices are present because of the local address.

The gateways and access nodes can additionally control the beacon air-time based on wireless mesh network operating and connection parameters. For example, each of the gateways and access nodes can monitor their latency and air-time consumption. If, for example, the latency and/or the air-time consumption of the device (gateway or access node) are higher than desired, the beacon air-time can be additionally reduced to reduce the chances that a client device will associate with the device. The air-time control can be triggered if, for example, the latency and/or the air-time consumption exceed a threshold, or a graduated set of thresholds.

Other wireless mesh network parameters can be additionally or alternatively used to control the air-time of the beacons. For example, the quality (for example, bandwidth, throughput or latency) of the backhaul connection of the gateways can be used to additionally control the beacon air-time. This can be done at the gateways themselves, or at access nodes that have the gateways as upstream devices.

Gateways can be provided with beacons that occupy greater air-time than access nodes. It may be desirable, for example, to provide a greater attraction of client devices to gateways than access nodes. This can include both attracting the client devices to gateways, and maintaining associations with gateways.

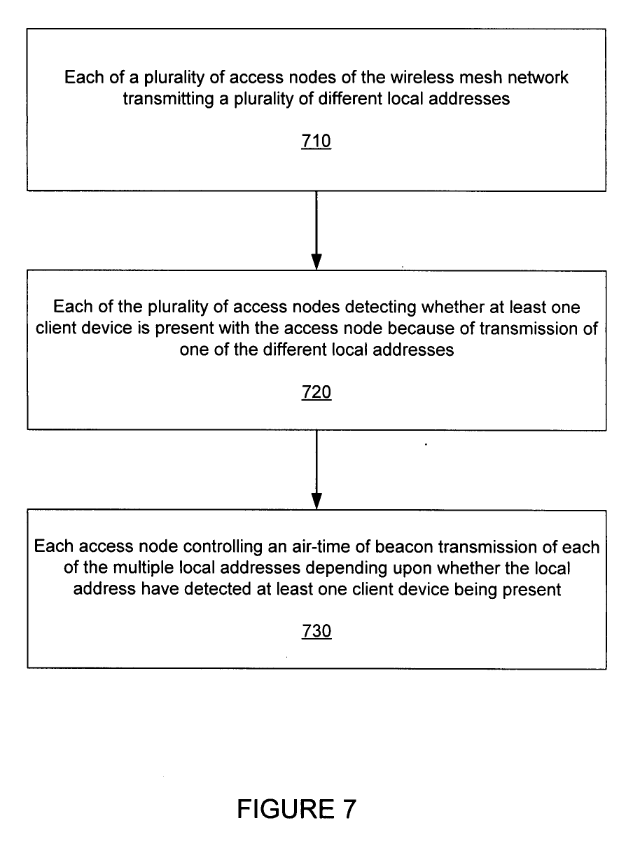

FIG. 7 show one example of a method of controlling beacons of multiple local addresses transmitted from a plurality of access nodes of a wireless mesh network. A first step 710 of the method includes each of a plurality of access nodes of the wireless mesh network transmitting a plurality of different local addresses. A second step 720 includes each of the plurality of access nodes detecting whether at least one client device is present with the access node because of transmission of one of the different local addresses. A third step 730 of the method includes each access node controlling air-time of beacon transmission of each of the multiple local addresses depending upon whether the local address have detected at least one client device being present.

As previously described, an example of detection of whether at least one client exists includes each access node at least one of detecting whether a client device recently probed the access node, whether a client device is associated with the access node, whether a client device recently dis-associated with the access node, and/or whether a client device has been authenticated.

Each access node can control air-time of beacon transmission of each of the multiple local addresses. For local addresses that do not have a detected client device, as previously described, the access node can increase a time interval between beacon transmissions, increase bit rates of the beacons, and/or decrease a preamble length of the beacons. Also, as previously described, if all client devices detected present for each local address are operating in a select mode (such as a sleep or idle mode) the air-time of the beacons can similarly be controlled.

Another embodiment includes each access node additionally controlling the air-time of beacon transmission of each of the multiple local addresses based on how many client devices are present because of the local address. That is, local addresses having fewer client devices present can be controlled be the access node to occupy less air-time than local addresses having more client devices.

The air-time control of the beacons can be extended to gateways of the wireless mesh network as well. However, beyond just detection of client devices and whether the client devices are in a sleep or idle mode, other factors can be used to determine how to control the air-time of the beacons. For example, the airtime of beacons transmission can depend upon at least one of backhaul connections of the gateways, bandwidth capacity, latency, and/or air-time consumption of the gateways and access nodes of the wireless mesh network.

An Embodiments of Beacon Timing Computer Program

An embodiment includes a computer program operable on an access node router of a wireless network. When executed, the computer program performs the following steps: the access node detecting a presence of a client device, and the access node controlling air-time of beacon transmission based on whether the access node detects the presence of a client device.

Although specific embodiments of the invention have been described and illustrated, the invention is not to be limited to the specific forms or arrangements of parts so described and illustrated. The invention is limited only by the appended claims.

What is claimed:

1. A method of an access node of a wireless network controlling beacon transmission, comprising:
the access node detecting a presence of a client device;
the access node controlling air-time of beacon transmission based on whether the access node detects the presence of a client device.

2. The method of claim 1, wherein the access node detecting the presence of a client device comprises at least one of detecting whether a client device recently probed the access node, whether a client device is associated with the access node, whether a client device recently dis-associated with the access node, whether a client device has been authenticated.

3. The method of claim 1, wherein controlling air-time of beacon transmission comprises at least one of controlling a time interval between beacon transmissions, controlling a rate of symbol transmission of the beacons, controlling a preamble length of the beacons.

4. The method of claim 1, wherein the access node transmits at least some beacons regardless of whether the access node detects the presence of a client device.

5. The method of claim 1, further comprising:
if a presence of a client device is detected, then determining a mode of the client device;
if the client device is in one of certain modes, then at least one of increasing a time interval between beacon transmissions, increasing bit rates of the beacons, decreasing a preamble length of the beacons.

6. The method of claim 5, wherein one of the modes comprises detecting client activity below a threshold.

7. The method of claim 5, wherein the mode comprises a power-save mode, and if the client device is in the power-save mode, then only transmitting beacons when an 802.11 beacon DTIM count is zero.

8. The method of claim 1, further comprising at least one of increasing a time interval between beacon transmissions, increasing bit rates of the beacons, decreasing a preamble length of the beacons, if no client devices are detected to be present by the access node.

9. The method of claim 1, further comprising controlling air-time of beacon transmission based on how many client devices the access node detects present.

10. The method of claim 9, wherein the air-time control is determined by referencing a schedule, wherein the schedule provides the air-time control depending upon how many client devices the access node detects.

11. A method of an access node of a wireless network controlling beacons sent from multiple local addresses, comprising:
detecting which of the multiple local addresses have at least one client device present;
controlling air-time of beacon transmission of each of the multiple local addresses depending upon whether the local address have detected at least one client device being present.

12. The method of claim 11, wherein controlling air-time of beacon transmission of each of the multiple local addresses comprises:
for local addresses that do not have a detected client device, increasing a time interval between beacon transmissions, increasing bit rates of the beacons, decreasing a preamble length of the beacons.

13. The method of claim 11, further comprising determining whether the at least one client device present for each local address are operating in a sleep mode.

14. The method of claim 13, wherein if all client devices detected present for each local address that are operating in the sleep mode, increasing a time interval between beacon transmissions, increasing bit rates of the beacons, decreasing a preamble length of the beacons, for each local address.

15. The method of claim 11, further comprising controlling the air-time of beacon transmission of each of the multiple local addresses based on how many client devices are present because of the local address.

16. A method of controlling beacons of multiple local addresses transmitted from a plurality of access nodes of a wireless mesh network, comprising:
each of a plurality of access nodes of the wireless mesh network transmitting a plurality of different local addresses;
each of the plurality of access nodes detecting whether at least one client device is present with the access node because of transmission of one of the different local addresses;
each access node controlling air-time of beacon transmission of each of the multiple local addresses depending upon whether the local address have detected at least one client device being present.

17. The method of claim 16, wherein each access node detecting whether at least one client device is present comprises each access node at least one of detecting whether a client device recently probed the access node, whether a client device is associated with the access node, whether a client device recently dis-associated with the access node, whether a client device has been authenticated.

18. The method of claim 16, wherein each access node controlling air-time of beacon transmission of each of the multiple local addresses comprises:
for local addresses that do not have a detected client device, increasing a time interval between beacon transmissions, increasing bit rates of the beacons, decreasing a preamble length of the beacons.

19. The method of claim 16, wherein if all client devices detected present for each local address that are operating in a select mode, increasing a time interval between beacon transmissions, increasing bit rates of the beacons, decreasing a preamble length of the beacons, for each local address.

20. The method of claim 16, further comprising each node controlling the air-time of beacon transmission of each of the multiple local addresses based on how many client devices are present because of the local address.

21. The method of claim 16, wherein the wireless mesh network further comprises gateways having local addresses, and the method further comprising:
the access nodes and gateways controlling the air-time of beacon transmission of each of the multiple local addresses depending upon whether the local address have detected at least one client device being present.

22. The method of claim 21, further comprising controlling the airtime of beacons transmission depending upon at least one of backhaul connections of the gateways, bandwidth capacity, latency, air-time consumption of the gateways and access nodes of the wireless mesh network.
